(19) United States
(12) Patent Application Publication
(10) Pub. No.: US 2017/0116453 A1
(43) Pub. Date: Apr. 27, 2017

(54) SYSTEMS AND METHODS FOR BIOMETRIC AUTHENTICATION CIRCUIT OFFSET FROM FRONT SURFACE OF DEVICE

(71) Applicant: Lenovo (Singapore) Pte. Ltd., New Tech Park (SG)

(72) Inventor: Srinivasan K. Ganapathi, Palo Alto, CA (US)

(21) Appl. No.: 14/921,320

(22) Filed: Oct. 23, 2015

(51) Int. Cl. G06K 9/00; G06F 3/041

(52) U.S. Cl. CPC G06K 9/00006; G06F 3/041; G06F 2203/04108

(57) ABSTRACT

In one aspect an electronic device includes a housing having a front surface, a display assembly positioned at a display portion of the front surface, a biometric authentication circuit offset from the front surface, and at least one sensor coupled to the biometric authentication circuit and positioned at a non-display portion of the front surface.

### FIELD

The present application relates generally to a biometric authentication circuit offset from a front surface of a device.

### BACKGROUND

Inclusion of biometric sensors into mobile and wearable electronics has proven difficult owing to the limited amount of room on such devices in which such a sensor may be disposed. As recognized herein, current solutions for including such sensors in these devices are inadequate, costly, and/or ineffective.

### SUMMARY

Accordingly, in one aspect an electronic device includes a housing having a front surface, a display assembly positioned at a display portion of the front surface, a biometric authentication circuit offset from the front surface, and at least one sensor coupled to the biometric authentication circuit and positioned at a non-display portion of the front surface.

In another aspect, an electronic device includes a housing having a front surface, a touch assembly positioned at the front surface, a biometric authentication circuit offset from the front surface, and at least one sensor coupled to the biometric authentication circuit and positioned at a portion of the front surface adjacent to the touch assembly.

In still another aspect, a method includes detecting a user gesture at a surface of a touch assembly and activating a particular sensor of a plurality of sensors, adjacent to the touch assembly, based on the user gesture.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a perspective view of an example film structure in accordance with present principles;

FIG. 4 is a side elevational view of an example film structure in accordance with present principles;

FIG. 5 is a front elevational view of an example film structure in accordance with present principles:

FIG. 6 is a transverse cross-sectional view of an example device in accordance with present principles;

FIG. 7 is a side cross-sectional view of an example device in accordance with present principles;

FIG. 8 is a front plan view of an example device m accordance with present principles;

FIG. 9 is a flow chart showing m example algorithm in accordance with present principles;

FIG. 10 is a front plan view of an example device in accordance with present principles;

FIG. 11 is a flow chart showing an example algorithm in accordance with present principles;

FIG. 12 is an example user interface (UI) in accordance with present principles; and

FIGS. 13-15 are example illustrations of present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that may not be a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information tirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

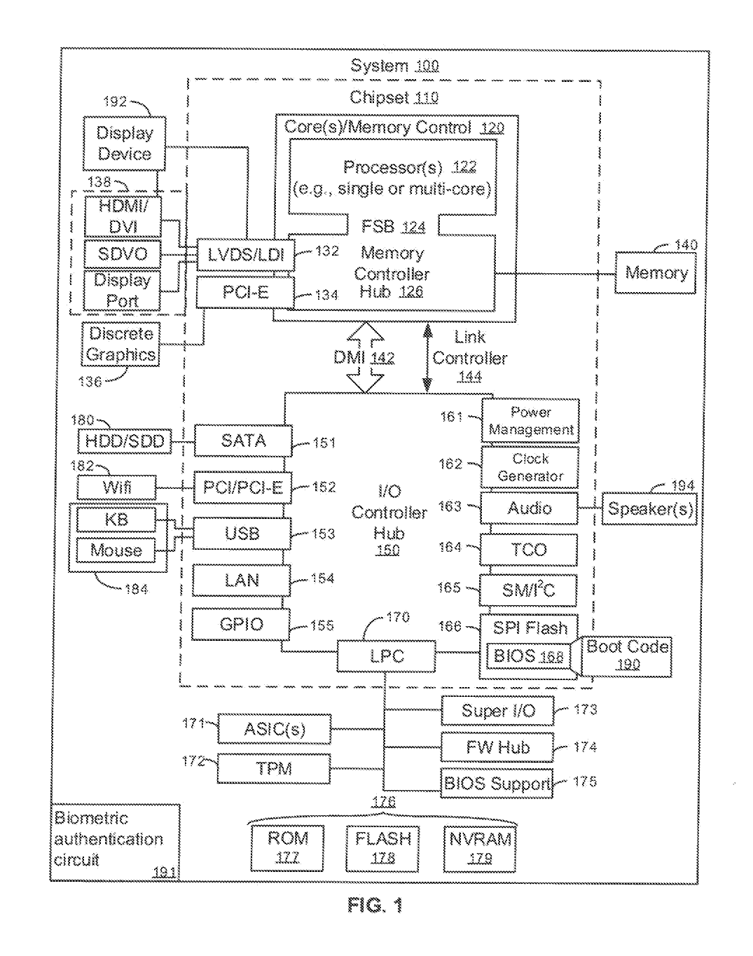

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX® or Playstation®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interlace (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interlace (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interlaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interlaces 152 (optionally one or more legacy PCI interfaces), one or more USB interfaces 153, a LAN interface 154 (more generally a network interface tor communication over at least one network such as the Internet, a WAN, a LAN, etc. under direction of the processors) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any ease the drives 180 are understood to be, e.g., tangible computer readable storage mediums that may not be transitory signals. The I/O hub controller 150 may also include an advanced host controller interface (AHCI) to support one or more drives 180. The PCI-E interface 152 allows for wireless connections 182 to devices, networks, etc. The USB interlace 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include at least one sensor assembly 191 for use in accordance with present principles. The sensor assembly 191 may comprise at least one biometric sensor (e.g., a capacitive swipe-based fingerprint sensor, an optical sensor, a vein sensor, etc.), other circuitry, and/or at least one application specific integrated circuit (ASIC) controlling the biometric sensor.

Additionally, though now shown for clarity, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 122, an audio receiver/microphone that provides input to the processor 122 based on, e.g., a user providing audible input to the microphone, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

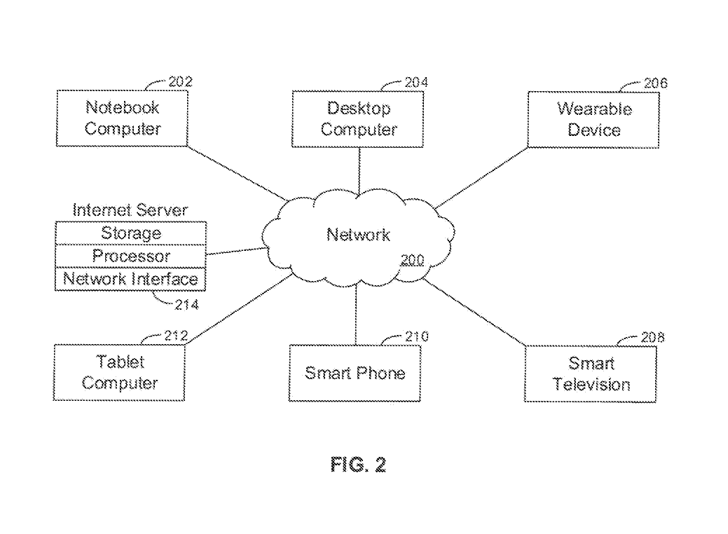

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles and may each have at least one fingerprint sensor as disclosed herein.

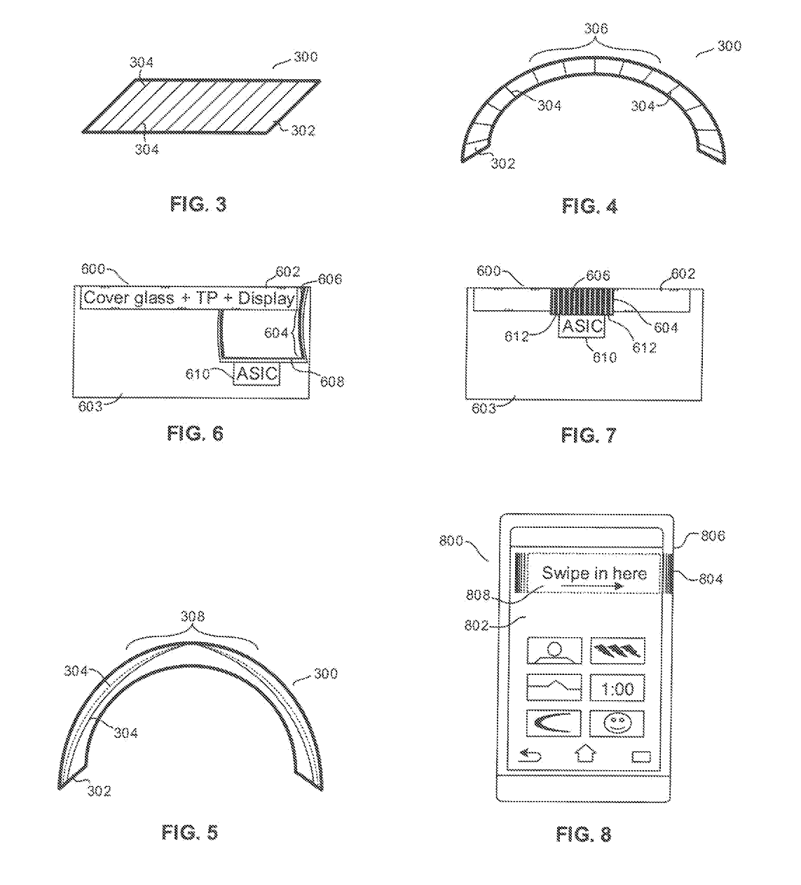

Now in reference to FIG. 3, it is a perspective view of an example film and/or circuit structure 300 that forms part of a fingerprint sensor and/or reader in accordance with present principles. The structure 300 comprises a flexible film 302 made of a material such as such as polyimide, polyethylene terephthalate, polyethylene naphthalate, another polymer, etc. The structure 300 also comprises one or more electrodes 304 on/in the film 302. The electrodes 304 may have a pitch of 50-70 micrometers, thus enabling acquisition of fingerprint input at, e.g., 500 dots-per-inch resolution. The electrodes 304 can be incorporated into the film 304 using one or more flex circuit fabrication processes known in the art. Furthermore, the electrodes 304 may be established at least in part by a single layer of metal or multiple layers of metal. Though not shown for clarity, the electrodes 304 are also understood to be electrically coupled to an application specific integrated circuit (ASIC) to provide input thereto.

As may be appreciated from the side elevational view of FIG. 4, the structure 300 is flexible so that it is bendable along a widthwise dimension of the rectangular structure 300. As may be appreciated from the front elevational view of FIG. 5, the structure 300 is also flexible so that it is bendable along a lengthwise dimension of the structure 300. As may be appreciated from FIG. 4, at least one and optionally plural electrodes 306 may be at or near an apex of the bent structure 300 for detecting fingerprint input directed to and/or at the apex shown in FIG. 4. As may be appreciated from FIG. 5, at least one and optionally each of the electrodes 308 may have portions at or near an apex of the bent structure 300 for detecting fingerprint input directed to and/or at the apex shown in FIG. 5.

However, whether the structure 300 is bent widthwise as shown in FIG. 4 or lengthwise as shown in FIG. 5, it may be positioned within a device as shown in FIG. 6, which may be, e.g., a smart phone or a wearable device such as a smart watch. FIG. 6 shows a transverse cross-sectional view of a portion of a device 600 having a display assembly 602 comprising a display, a touch-sensitive pad/sensor, and cover glass protecting the touch-enabled sensor and display and facing exterior to the device 600, while FIG. 7 shows a side cross-sectional view of a similar portion of the device 600.

The device 600 also comprises a housing 603 having a front surface that establishes a plane at least parallel to if not coplanar with a plane established by an exterior surface of the display assembly 602. Also, an apex 606 of a bent portion 604 of a film structure is positioned at, proximate to, and/or exposed to the plane established by the exterior surface of the display assembly 602. The bent portion 604 is at least similar in function and configuration to the structure 300 described above, and at least in part establishes a fingerprint sensor and/or reader 608. The bent portion 604 may be bent widthwise or lengthwise as described above in reference to FIGS. 4 and 5, but in either case is positioned between an edge of the display assembly 602 and edge of the housing 603 as shown in FIG. 6. The portion 604 may be attached to a portion of the device 600, such as the display assembly 602 (and/or housing 603), and such that its electrodes face inward relative to the bend or outward relative to the bend. Example electrodes 612 are shown in FIG. 7. Additionally, the portion 604 may be attached to a portion of the device 600 such as the edge of the display assembly 602 using, e.g., epoxy, resin, optically clear adhesive, pressure sensitive adhesive (PSA), etc.

Furthermore, as may be appreciated from FIG. 6, in addition to the bend in this structure resulting in the apex 606, film of the fingerprint sensor 608 extending away from the portion 604 may also be bent or folded such that it extends perpendicular to an axis established by the portion 604 and under the display assembly 602 as shown in FIG. 6.

As may also be appreciated from FIG. 6, the sensor 608 and/or electrodes therein are coupled to (e.g., via a conduit) and configured to communicate with a biometric authentication circuit and/or application specific integrated circuit (ASIC) 610 (e.g., and/or any other associated silicon addressing circuitry and analog front end (AFE) electronics for communicating with a central processing unit (CPU) or another processor of the host device itself). The ASIC 610 is offset from the front surface of the housing 603 by at least a thickness of the display assembly 602, and is positioned behind the display assembly 602 relative to the front surface (and hence under the display assembly 602 relative to the perspective shown). The ASIC 610 may serve as both the drive circuit as well as the signal processing circuit for the fingerprint reader, and may also communicate with the host device in which it is disposed (e.g., a phone, tablet, laptop, etc.) using interface protocols such as SPI, USB, I2C, etc. Additionally, it is to be understood that the ASIC 610 verifies a match between a biometric input sample received via the apex 606 and a biometric template as will be described further below.

Regardless, it is to be understood that at least a portion of at least one of the electrodes 612 in the film (e.g., and in some embodiments, bent portions (e.g., tips) of more than one electrode 612 at or near the apex 606, such as when the film is folded lengthwise) is positioned at or just beneath the plane establishing the exterior surface of the display assembly 602 such that at least the bent portion is at least proximate to if not flush with the plane and hence exterior surface of the display assembly 602 so that it may sense a person's finger after it has slid across and off the display toward the portion 604. Furthermore, this portion(s) of the electrode(s) may or may not be exposed to outside of the device 600. For instance, it/they may be encapsulated within the flex circuit film, and/or covered with an insulating layer positioned between the electrodes and the outside to protect them from mechanical, chemical or environmental damage, etc. Notwithstanding, it is to be understood that whether this portion(s) is disposed slightly recessed from the plane establishing the exterior surface of the display assembly 602 or flush with it, it is positioned accordingly so that an input signal may still be adequately detected to distinguish between ridges and valleys of a fingerprint.

Continuing the detailed description now in reference to FIG. 8, it shows an example front plan view of a device 800 that has a display assembly 802 at least similar in function and configuration to the assembly 602 described above. The device 800 also has at least one fingerprint sensor at least similar to the fingerprint sensor and/or reader 608 described above and understood to have a bent portion and/or apex portion 804 flush with or slightly recessed from a plane established by the exterior surface of the display assembly 802. The portion 804 is also disposed between the assembly 802 and a side wall 806 of a housing of the device 800.

FIG. 8 also shows that a prompt 808 is presented on the assembly 802 in some cases. The prompt 808 instructs a person (e.g., using words and/or graphics, such as the words and arrow shown in FIG. 8) on an area and direction within the area in which to slide their finger against the exterior surface of the assembly 802 and across the portion 804 (and even off the edge of the housing of the device 800 away from the device), and even a starting location on the assembly 802 for the sliding, to one or more of: (A) singlehandedly unlock the device and provide fingerprint input in a single, uninterrupted, and/or continuous motion, (B) singlehandedly provide touch input to the device and provide fingerprint input in a single, uninterrupted, and/or continuous motion, (C) singlehandedly provide fingerprint input in a single, uninterrupted, and/or continuous motion, etc. Based on the person swiping their linger across the portion 804 (e.g., transversely left to right such that more than one vertical segment of their finger slides across the portion 804), signals may be received from the electrodes and the fingerprint reader is able to map at least a portion of the user's fingerprint and/or reproduce the sensed portion of the fingerprint.

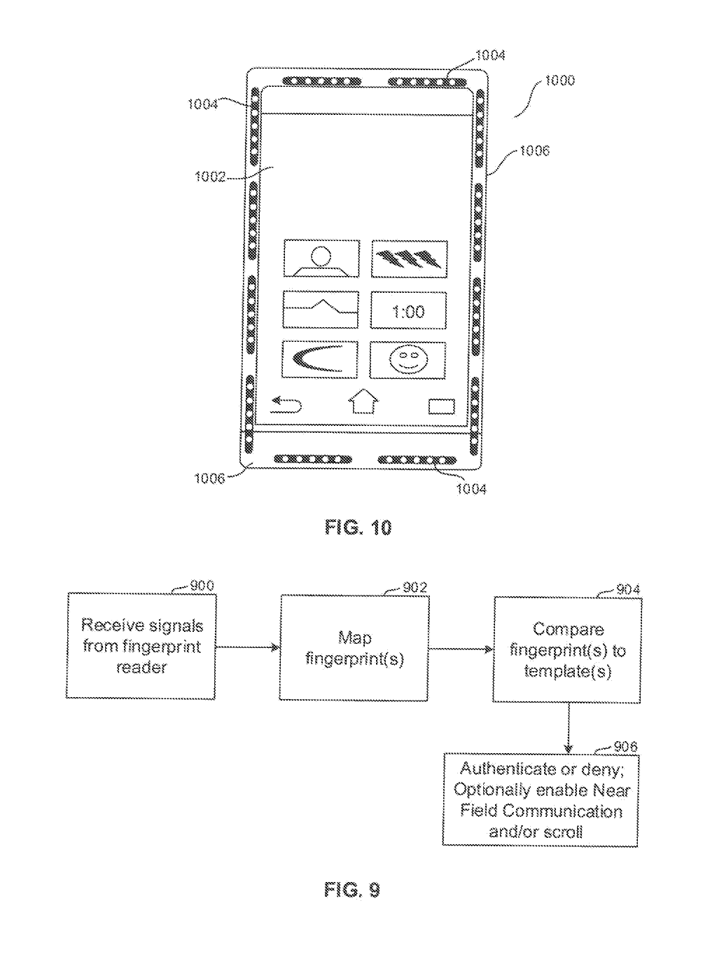

Now in reference to FIG. 9, it shows example logic that maybe undertaken by a device, such as the system 100, in accordance with present principles for performing a fingerprint authentication based on input received at a portion of a fingerprint reader such as the portion 804 described above as a person slides their finger across the portion. The device undertaking the logic of FIG. 9 will be referred to below as the “present device.”

Beginning at block 900, with the fingerprint reader actuated and/or turned on (e.g., along with a display assembly on the present device), the logic receives successive signals from a portion of the fingerprint reader (FPR), such as from electrodes at one of the apices and/or bent portions described herein, as a user slides a finger across the portion. Then, based on the successive signals received at block 900, at block 902 the logic maps the portion of the linger slid across the portion and/or generates a representation of this portion of the finger. The logic may do so at block 902 on a per-electrode basis, for example, such that successive signals received from a single electrode may be used to identify and map (e.g., generate an image of and/or metadata related to) fingerprint peaks and valleys along a segment of the finger as the segment is slid across the respective electrode.

From block 902 the logic then proceeds to block 904 where the logic compares the mapped fingerprint as determined based on input from the fingerprint reader to a fingerprint template stored at the present device. Responsive to the mapped fingerprint matching the template as determined at block 904 (or at least responsive to a mapped portion and/or threshold amount of the user's fingerprint matching at least a corresponding portion of the template), the logic authenticates the user at block 906. Responsive to the mapped fingerprint failing to match the template as determined at block 904, the logic denies authentication at block 906. Furthermore, and also at block 906 responsive to the mapped fingerprint matching the template, the logic may do one or more of permit a level of access to the present device, enable near field communication (NFC) using the present device and/or enable an NFC antenna embedded in the fingerprint reader as will be described further below, and/or enable scrolling using input to fingerprint sensors on the present device as will be described further below.

Continuing the detailed description in reference to FIG. 10, it shows an example front plan view of a device 1000 that has a display assembly 1002 at least similar in function and configuration to the assembly 602 described above. The device 1000 also has plural fingerprint sensors at least similar to the fingerprint sensor and/or reader 608 described above and understood to have respective bent portions and/or apices 1004 flush with or slightly recessed from a plane established by the exterior surface of the display assembly 1002. As may be appreciated from FIG. 10, the portions 1004 are respectively disposed along portions the periphery of the assembly 1002 between the assembly 1002 and side walls of the device's housing 1006.

At least some of the plural fingerprint sensors shown in the device 1000 may abut each other end to end (e.g., at respective end segments of the flexible film portions) along the periphery of the display assembly 1002, and/or may be separated from each other along the periphery by a threshold distance. By disposing the fingerprint sensors on the device 1000 as shown and described, a user is able to swipe and/or slide a finger in plural (e.g., any) directions across the exterior surface of the display assembly 1002, across the portions 1004, and off various edge portions of the device 1000 along the plane of the exterior surface to thus provide fingerprint input (e.g., in an uninterrupted and/or continuous motion) to at least one of the portions 1004 in accordance with present principles (e.g., to unlock and/or access the device 1000, to map the fingerprint, to authenticate the user based on the fingerprint, to enable scrolling using at least one of the FPRs, to enable NFC, etc.).

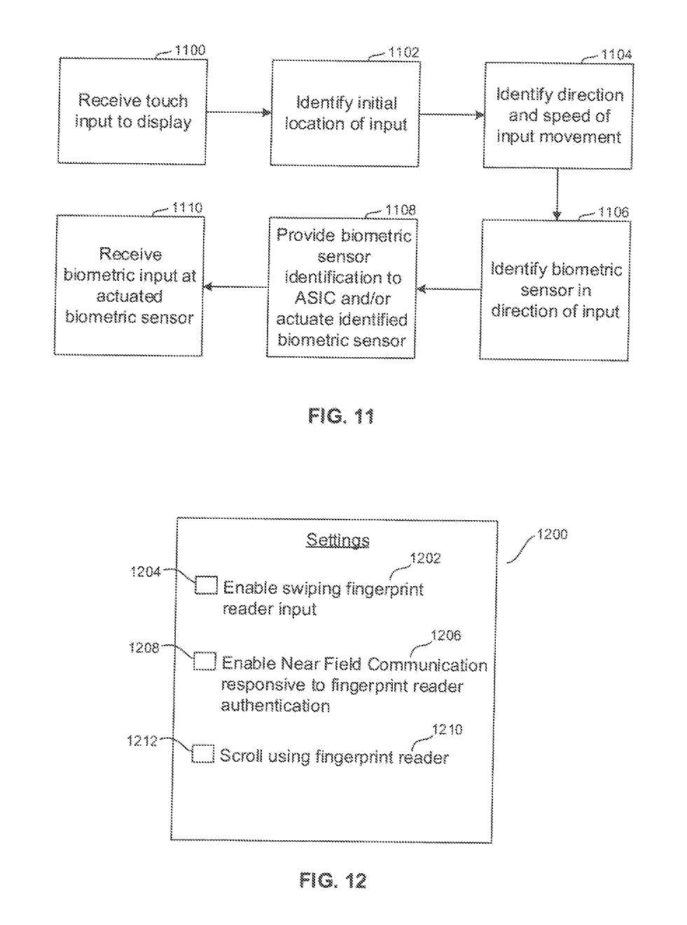

As recognized herein, in some instances all of the fingerprint readers disposed at or near edges of the device as shown in FIG. 10 may be concurrently turned on to receive fingerprint input, such as responsive to receipt of a command to illuminate the display and/or responsive to the press of a button on the device 1000. However, in some embodiments where power is desired to be saved and/or a certain level processing speed is desired to be maintained, only a fingerprint reader(s) in the direction in which the user's finger is identified as moving may be turned on to receive fingerprint input. FIG. 11 shows example logic that may be undertaken by a device, such as the system 100 and/or device 1000, in accordance with present principles for identifying the direction of a finger slide and hence which fingerprint reader to actuate and/or turn on. The device undertaking the logic of FIG. 11 will be referred to below as the “present device.”

Beginning at block 1100, the logic of FIG. 11 receives initial touch input (e.g., a gesture) to a location on the present device's display (e.g., as identified by the display's touch-sensitive pad). Then at block 1102 the logic identifies the location (e.g., identifies X and Y display coordinates corresponding to the location that is touched). After block 1102, the logic proceeds to block 1104 where the logic identifies a direction (relative to the initially touched location) and speed (and/or velocity) of the gesture as the touch input continues to be received at the display owing to the user sliding their finger (e.g., without interruption) across the display. The logic may do so at block 1104, e.g., by identifying additional X and Y coordinates of touched display locations, and times at which inputs to the respective display locations are received to identify speed (and/or velocity) based on a change in distance over time.

The logic of FIG. 11 then continues to block 1106 where the logic identifies a particular fingerprint sensor at an edge of the display in the direction in which the input is being provided. The logic may do so by identifying a location at an edge of the display at which the sliding input is approaching and then identifying the most proximate fingerprint reader to the location at the edge.

In some cases, at block 1106 the logic may identify plural fingerprint readers proximate to such a location at the edge, such as identifying the most proximate fingerprint reader and the second-most proximate fingerprint reader to the location. Also in some cases, at block 1106 the logic may identify plural fingerprint readers that are both proximate to a location at an edge of the display at either side of the location of the edge of the display, such as when there is no fingerprint sensor positioned at the edge itself.

Regardless, but still in reference to FIG. 11, from block 1106 the logic proceeds to block 1108 where the logic provides identifying information for the particular fingerprint sensor to the ASIC in the present device controlling at least the particular fingerprint sensor that is identified (e.g., if not controlling all fingerprint sensors on the device) so that the ASIC may actuate/turn on the fingerprint reader at a threshold time before the user's finger is estimated to arrive at the particular fingerprint sensor based on the slide speed (and/or velocity) identified at block 1104. Also at block 1106, in addition to or in lieu of providing the identifying information to the ASIC, the logic may itself actuate/turn on the fingerprint reader at a threshold time before the user's finger is estimated to arrive at the particular fingerprint sensor based on the slide speed (and/or velocity) identified at block 1104. The logic may then move to block 1110 where the logic receives fingerprint input at the particular fingerprint sensor that is actuated/turned on. At block 1110 the logic may also take another action based on receipt of the fingerprint input, such as enabling NFC communication as described herein.

Moving on, reference is now made to FIG. 12. FIG. 12 shows an example user interface (UI) 1200 presentable on a display of a device configured to undertake present principles. The UI 1200 is understood to be for configuring one or more settings of the device. Thus, the UI 1200 includes a first option 1202 enableable based on selection of check box 1204 to enable receipt of fingerprint input while a user swipes across the device's display and across at least one fingerprint sensor as disclosed herein.

The UI 1200 also includes a second option 1206 enableable based on selection of check box 1208 to enable NFC communication responsive to successful fingerprint authentication as disclosed herein. Still further, the UI 1200 includes a third option 1210 enableable based on selection of check box 1212 to scroll a page and/or UI presented on the device's display based on scroll input received at one or more fingerprint sensors on the device as disclosed herein.

Now describing how near field communication (NFC) can be used in accordance with present principles, it is to be understood that an NFC antenna (and/or the NFC communication chip itself) may fee integrated into a fingerprint sensor in accordance with present principles, such as the antenna being integrated into a flexible film of the fingerprint sensor described above and the NFC chip communicating with the antenna being integrated into another portion of the fingerprint sensor. Furthermore, when plural fingerprint sensors are included between a display assembly edge and housing edge as disclosed herein, each respective sensor may have its own respective NFC antenna/chip embedded therein, making NFC communication of the device with another device relatively easier owing to any one of the NFC antennas being usable to communicate rather than a user having to position the device in but one particular orientation for NFC communication with an NFC scanner or other NFC communication device, while also enabling relatively strong communication of NFC signals owing to the antennas' proximity to exterior of the device. Even further, and as discussed above, in some embodiments NFC communication using these NFC communication elements may be enabled responsive to successful fingerprint authentication using a fingerprint sensor as disclosed herein, while NFC communication may be disabled while no fingerprint authentication has even been attempted and also responsive to unsuccessful fingerprint authentication.

Now describing the scrolling referenced herein that may be performed using a fingerprint sensor, it is to first be understood that since a bent and/or U-shaped portion of a flexible film as described herein may be disposed (e.g., in the bezel of the device) between a display assembly of a device and a side edge of the device's housing (e.g., a side surface of the housing at least substantially orthogonal to the front surface of the device and/or plane established by the exterior surface of the display assembly), input may be sensed by portions the electrodes in the film other than at the bent portion and/or apex through the relatively thin side wall of the housing (e.g., in addition to being sensed at the apex through the front of the bezel and/or front surface). Thus, in some embodiments, when input is sensed by the fingerprint sensor from along the side of the device in a direction at least substantially parallel to an axis established by the respective side of the device, this input may be identified as a scroll command, such as to scroll in the direction of the finger movement, and a scroll may fee executed accordingly (e.g., to scroll a web page, word processing document, etc.). Furthermore, in some example embodiments, scrolling may be enabled responsive to successful fingerprint authentication using a fingerprint sensor, while scrolling may be disabled while no fingerprint authentication has even been attempted and also responsive to unsuccessful fingerprint authentication.

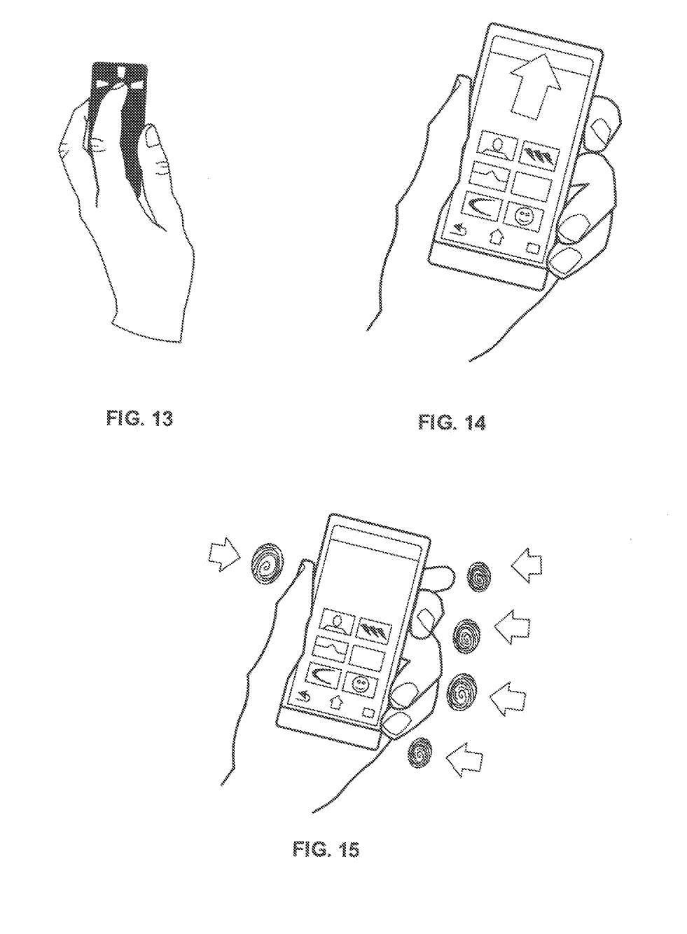

Continuing the detailed description in reference to FIGS. 13 and 14, they show example illustrations of present principles. FIGS. 13 and 14 respectively show a device in accordance with present principles from a backside of the device and front side of the device. As may be appreciated from FIG. 13, at least a portion of the flexible film of a fingerprint sensor may wrap around the backside of the device (in addition to having a bent portion juxtaposed close to if not at the front side of the device) such that it is between other device components and the back of the housing of the device. Thus, a user may scroll as disclosed herein based on input detected by this portion of the film positioned against the inside of the back of the housing (which, in some embodiments, may also be used to sense fingerprint input). The arrow shown in FIG. 14 illustrates a direction of scroll corresponding to a direction of movement of the user's finger as represented in FIG. 13.

Now in reference to FIG. 15, it illustrates that in some instances, such as to activate and/or launch a particular application stored at the device, to execute a particular function at the device, and/or for higher security authentication, a device in accordance with present principles may require plural lingers contact respective fingerprint sensors concurrently or at least within a threshold time of each other. Thus, FIG. 15 illustrates that in some examples, all five fingers for a given hand may have their fingerprints concurrently read by respectively juxtaposed fingerprint readers juxtaposed at or near front and side surfaces on the device as shown. Furthermore, in some embodiments the specific combination of fingers may vary depending on which particular application, function, and/or security feature is to be automatically launched (without further user input) responsive to authentication of the specific combination of fingers. Even further, in some example embodiments a specific combination of fingerprint input can cause the device to automatically generate raid transmit to another (predefined and/or user-specified) device duress, help, and/or SOS signals or alarms.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

While the particular SYSTEMS AND METHODS FOR BIOMETRIC AUTHENTICATION CIRCUIT OFFSET FROM FRONT SURFACE OF DEVICE is herein shown and described in detail, it is to be understood that the subject matter which is encompassed by the present application is limited only by the claims.

1. An electronic device comprising:
a housing having a front surface;
a display assembly positioned at a display portion of the front surface;
a biometric authentication circuit offset from the front surface; and
at least one sensor coupled to the biometric authentication circuit and positioned at a non-display portion of the front surface, the at least one sensor having a plurality of electrodes, the at least one sensor arranged on the electronic device to have a fold that establishes an apex at least proximate to the front surface so that a first portion of at least a first electrode of the plurality of electrodes is able to receive input via the front surface while a second portion of the first electrode is unable to receive input via the front surface.

2. (canceled)

3. The electronic device of claim 1, wherein the biometric authentication circuit is offset from the surface of the housing by at least a thickness of the display assembly.

4. The electronic device of claim 1, wherein the biometric authentication circuit is positioned behind the display assembly relative to the front surface.

5-8. (canceled)

9. An electronic device comprising:
a housing having a front surface;
a touch assembly positioned at the front surface;
a biometric authentication circuit offset from the front surface; and
at least one sensor coupled to the biometric authentication circuit and positioned at a portion of the front surface adjacent to the touch assembly, the at least one sensor having a plurality of electrodes, the at least one sensor arranged on the electronic device to establish an apex at least proximate to the front surface so that a first portion of at least a first electrode of the plurality of electrodes is able to receive input via the front surface.

10. (canceled)

11. The electronic device of claim 9, wherein the biometric authentication circuit is offset from the surface of the housing by at least a thickness of the touch assembly.

12. The electronic device of claim 9, wherein the biometric authentication circuit is positioned behind the touch assembly relative to the front surface.

13-16. (canceled)

17. A method, comprising:
detecting, at an electronic device, a user gesture at a surface of a touch assembly of the electronic device, the touch assembly being is positioned at a front of the electronic device; and
activating a sensor adjacent to the touch assembly based on the user gesture, the sensor having at least one electrode, the sensor positioned on the electronic device to establish a fold at least proximate to the front of the electronic device so that a first portion of the electrode is able to receive input via the front surface.

18-20. (canceled)

21. The electronic device of claim 1, wherein the at least one sensor is activated responsive to illumination of a display of the display assembly.

22. The electronic device of claim 1, wherein the at least one sensor is activated responsive to the press of a button on the electronic device.

23. The electronic device of claim 1, wherein the second portion of at least the first electrode is arranged on the electronic device to receive input via a side surface of the electronic device relative to the front surface.

24. The electronic device of claim 23, comprising a processor and storage accessible to the processor, the storage bearing instructions executable by the processor to:
execute a scroll command responsive to receipt of input to the second portion of at least the first electrode but not execute a scroll command responsive to receipt of input to the first portion of at least the first electrode.

25. The electronic device of claim 1, comprising a processor and storage accessible to the processor, the storage bearing instructions executable by the processor to:
enable near field communication responsive to successful fingerprint authentication using the fingerprint authentication circuit, the near field communication being enabled using a near field communication element having an antenna juxtaposed at least partially in the at least one sensor.

26. The electronic device of claim 1, comprising a processor and storage accessible to the processor, the storage bearing instructions executable by the processor to:
present a prompt via the display assembly, the prompt indicating a portion of the display assembly at which to direct a slide-to-unlock gesture that also results in fingerprint input being provided to the at least one sensor.

27. The electronic device of claim 1, comprising a processor and storage accessible to the processor, the storage bearing instructions executable by the processor to:
present a prompt via the display assembly, the prompt indicating a portion of the display assembly at which to direct a gesture for providing input other than fingerprint input but that also results in fingerprint input being provided to the at least one sensor.

28. The electronic device of claim 1, comprising a processor and storage accessible to the processor, the storage bearing instructions executable by the processor to:
present a user interface (UI) via the display assembly, the UI comprising an option that is selectable to enable use of the at least one sensor to receive fingerprint input during a user's performance of a swiping gesture.

29. The electronic device of claim 9, wherein a second portion of the first electrode is arranged on the electronic device so that it is unable to receive input via the front surface but is able to receive input via another surface of the electronic device.

30. The electronic device of claim 29, comprising a processor and storage accessible to the processor, the storage bearing instructions executable by the processor to:
execute a scroll command responsive to receipt of input to the second portion of at least the first electrode.

31. The electronic device of claim 9, comprising a processor and storage accessible to the processor, the storage bearing instructions executable by the processor to:
enable near field communication responsive to successful fingerprint authentication using the biometric authentication circuit, the near field communication being enabled using a near field communication element having an antenna juxtaposed at least partially in the at least one sensor.

32. The method of claim 17, wherein a second portion of the electrode is positioned on the electronic device so that it is unable to receive input via the front of the electronic device but is able to receive input via another portion of the electronic device, and wherein the method comprises:
executing a scroll command responsive to receipt of input to the second portion of the electrode.

33. The method of claim 17, comprising:
enabling near field communication responsive to successful authentication of a user using input received at the first portion of the electrode, the near field communication being enabled using a near field communication element having an antenna juxtaposed at least partially in sensor.
